(19) United States
(12) Patent Application Publication
(10) Pub. No.: US 2017/0163521 A1
(43) Pub. Date: Jun. 8, 2017

(54) ZIGBEE NETWORK SYSTEM AND THE BACKUP METHOD THEREOF

(71) Applicants: INVENTEC APPLIANCES (PUDONG) CORPORATION, Shanghai (CN); INVENTEC APPLIANCES CORP., New Taipei City (TW)

(72) Inventor: Sheng-Hsiung HU, New Taipei City (TW)

(21) Appl. No.: 15/061,655

(22) Filed: Mar. 4, 2016

(30) Foreign Application Priority Data
Dec. 3, 2015 (CN) 201510881519.X

(51) Int. Cl. H04L 12/707; H04W 40/34; H04W 4/00; H04W 24/04

(52) U.S. Cl. CPC H04L 45/22; H04W 24/04; H04W 40/34; H04W 4/008

(57) ABSTRACT

A Zigbee network system comprises a backup Zigbee coordinator, a Zigbee coordinator, and at least a router, and the network group data is instantly copied to the backup Zigbee coordinator. In this way, the backup Zigbee coordinator can replace the broken Zigbee coordinator, so that there is no need to restart the Zigbee network system. Accordingly, user can seamlessly transmit the data through the Zigbee network system without the influence of the broken Zigbee coordinator.

### CROSS-REFERENCES TO RELATED APPLICATIONS

The application claims priority to China Patent Application No. 201510881519.X, filed on Dec. 3, 2015 the content of which are hereby incorporated by reference in their entirety.

### FIELD OF THE INVENTION

The present invention relates to a network system, particularly relates to a Zigbee network system having a backup function and a backup method thereof.

### BACKGROUND OF THE INVENTION

A Zigbee network is generally consisted of a Zigbee coordinator, some routers and an end device. One router has one terminal connected with the Zigbee coordinator and the other terminal connected with the end device. When the Zigbee coordinator launches, it may generate an identification (ID) for forming the Zigbee network. Based on the existence of the Zigbee coordinator in the current Zigbee network, it is necessary for another one that would like to join the current Zigbee network to be converted into the one of router function before it joins the current Zigbee network. As a result, there is only one Zigbee coordinator for a Zigbee network. The single Zigbee coordinator needs to be interrupted for the replacement of another one of normal function, once it is abnormal in the Zigbee network. In this case, the Zigbee network needs to be reinitialized for recovery of functions in the Zigbee network. However, it is inconvenient for user to interrupt data transmission for the replacement of the Zigbee coordinator of normal function and wait for the reinitialization success on the Zigbee network to resend data. As a result, data transmission is delayed by the replacement of the Zigbee coordinator and the reinitialization of the Zigbee network.

One of current resolution approaches is to amend the source code of a router to make the router capable of operating as the Zigbee coordinator and become a new Zigbee coordinator, because the functions of the router are same as the ones of the Zigbee coordinator. Provided that a primary Zigbee coordinator is functioning abnormally, it may be replaced by a new Zigbee coordinator and the new Zigbee coordinator needs to be initialized. However, the initialization of the new Zigbee coordinator needs to reform the Zigbee network and the identification, search all previous apparatuses within the Zigbee network, and enable all the apparatuses rejoin the Zigbee network. Though such approach makes the Zigbee coordinator of back-up function, however, it is not seamless transition.

Another one of resolution approaches utilizes double-hard design. A physical layer/MAC layer at the bottom layer of the Zigbee network plays a main role on making a copy (back-up). Usually the main Zigbee coordinator is in charge of operating and judged whether operating normally by an added software (SW) layer. Once the main Zigbee coordinator is judged to function abnormally, a back-up Zigbee coordinator is launched to transmit data between the back-up Zigbee coordinator at the bottom layer and the application layer of an upper layer, so as to enable the Zigbee network operate normally. However, such a pure-hardware back-up approach can not enable the Zigbee network operate normally if there are troubles on a network or the application layer.

### SUMMARY OF THE INVENTION

Accordingly, a main objective of the present invention provides a back-up Zigbee coordinator to be assigned in a Zigbee network system. Network group data stored in a primary Zigbee coordinator can be instantly back-up to the back-up Zigbee coordinator, so that the back-up Zigbee coordinator can instantly replace a damaged Zigbee coordinator without reinitializing the Zigbee network. As a result, a damaged Zigbee coordinator can not interrupt data transmission in the Zigbee network, so that user can seamlessly go on data transmission.

Accordingly, a Zigbee network system includes: a primary Zigbee coordinator; a Zigbee router wirelessly connected with the primary Zigbee coordinator; and a back-up Zigbee coordinator communicatively coupled with the primary Zigbee coordinator and configured to receive a network group data from the primary Zigbee coordinator, wherein the back-up Zigbee coordinator is further configured to send a query signal to the primary Zigbee coordinator, and includes a first wireless transceiver configured to become operational to wirelessly connect with the Zigbee router if the back-up Zigbee coordinator does not receive a query response indicating the primary Zigbee coordinator is functioning normally.

Accordingly a Zigbee coordinator configured to communicatively couple with a counterpart Zigbee coordinator is provided herein, the Zigbee coordinator comprising: a communication module configured to send a query signal to the counterpart Zigbee coordinator, and further configured to receive a network group data from the counterpart Zigbee coordinator; a storage module configured to store the network group data; and a wireless transceiver configured to become operative to wirelessly connect the Zigbee coordinator with a Zigbee router if the Zigbee coordinator does not receive a query response indicating the counterpart Zigbee coordinator is functioning normally.

Accordingly, a method for substituting a primary Zigbee coordinator in a Zigbee network system includes: providing a back-up Zigbee coordinator communicatively coupled with the primary Zigbee coordinator, the back-up Zigbee coordinator comprising a memory storing a network group data received from the primary Zigbee coordinator; querying if the primary Zigbee coordinator is functioning normally; and if the primary Zigbee coordinator is not functioning normally, connecting the back-up Zigbee coordinator to the Zigbee network system using the network group data.

### BRIEF DESCRIPTION OF THE DRAWINGS

FIG. 1 is a schematic block diagram illustrating a first exemplary Zigbee network system according to the present invention.

FIG. 2 is a schematic block diagram illustrating a backup Zigbee coordinator of the first exemplary Zigbee network system according to the present invention.

FIG. 3 is a schematic block diagram illustrating a second exemplary Zigbee network system according to the present invention.

FIG. 4a˜FIG. 4b are schematic flow diagrams illustrating a backup method for the first exemplary Zigbee network system according to the present invention.

### DETAILED DESCRIPTION OF THE PREFERRED EMBODIMENT

A Zigbee network system is disclosed in the present invention, in which structures and principles of router and Zigbee coordinator are well known by one of general knowledge in the field, so they will not be illustrated in detail. The presently described embodiments will be understood by reference to the drawings, but the sizes or ratios of components shown in drawings are not intended to limit the scope of the disclosure.

The present invention relates to a Zigbee network system, and particularly relates to a Zigbee network system with a backup Zigbee coordinator, at least a router, and a primary Zigbee coordinator.

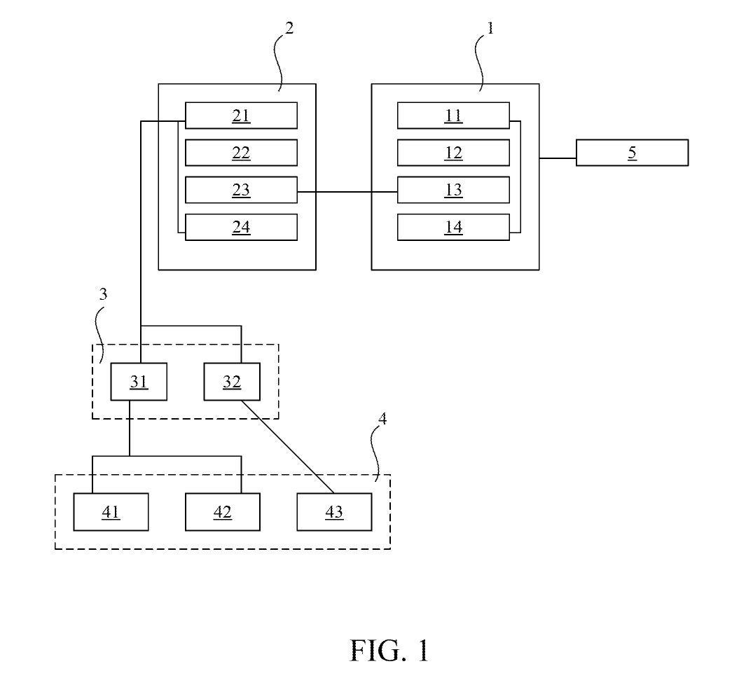

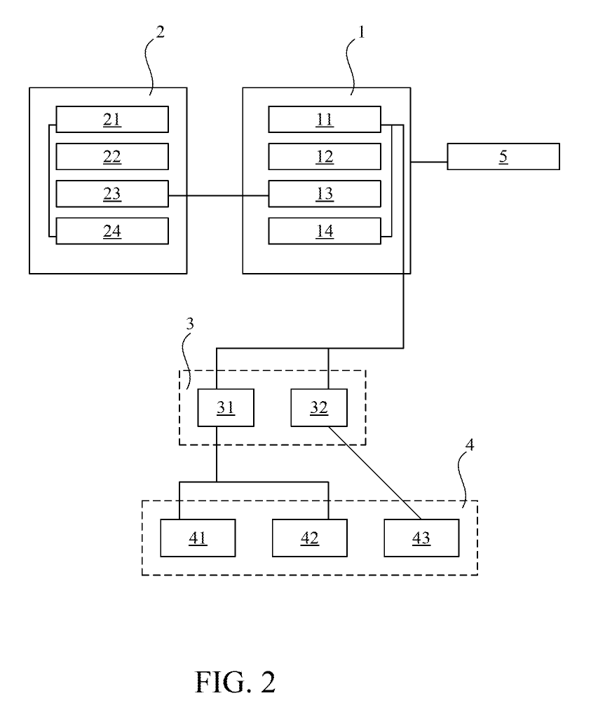

Please refer to FIG. 1 and FIG. 2. FIG. 1 is a schematic block diagram illustrating a first exemplary Zigbee network system according to the present invention. FIG. 2 is a schematic block diagram illustrating a backup Zigbee coordinator of the first exemplary Zigbee network system according to the present invention.

Shown in FIG. 1, a Zigbee network system includes a back-up Zigbee coordinator 1, a primary Zigbee coordinator 2, and a router group 3. The router group 3 includes a router 31 connected to two end devices 41 and 42, and another router 32 connected to another end device 43. Furthermore, the back-up Zigbee coordinator 1 includes a first wireless transceiver 11, a first processing module 12, a first communication module 13, and a first storing module 14. The primary Zigbee coordinator 2 includes a second wireless transceiver 21, a second processing module 22, a second communication module 23, and a second storing module 24. The first communication module 13 is connected with the second communication module 23, the first processing module 12 is connected with the first wireless transceiver 11 and the first communication module 13, the first storing module 14 is connected with the first wireless transceiver 11 and the first communication module 13, the second processing module 22 is connected with the second communication module 23 and the second wireless transceiver 21, and the second storing module 24 is connected with the second communication module 23 and the second wireless transceiver 21. The first wireless transceiver 11 is configured to generate a radio frequency (RF) of the back-up Zigbee coordinator 1, the second wireless transceiver 21 is configured to generate another radio frequency of the primary Zigbee coordinator 2. Both the first storing module 14 and the second storing module 24 are configured to store network group data such as a Personal Area Network ID, a long address, a short address, and a routing table.

Please refer to FIG. 1 again and take an example in practice. In the case that the primary Zigbee coordinator 2 is a main coordinator for a Zigbee network, the second wireless transceiver 21 of the primary Zigbee coordinator 2 is turned on and generates the RF of the primary Zigbee coordinator 2. Meanwhile, the first wireless transceiver 11 is turned off. With the RF of the second wireless transceiver 21, the primary Zigbee coordinator 2 connects to the router 31 and the router 32. Provided that the end devices 41, 42 and 43 do not link to a current Zigbee system or there is other end device to join the current Zigbee system, the network group data will be updated, and the routers 31 and 32 may transmit the updated network group data via the second wireless transceiver 21 to the second storing module 24 for storing. The back-up Zigbee coordinator 1 may be connected with an exterior user's mailbox 5. The first communication module 13 of the back-up Zigbee coordinator 1 sends a network data request to the second communication module 23 of the primary Zigbee coordinator 2. In response to the network data request, the second communication module 23 outputs the network group data from the second storing module 24 to the first communication module 13. The first communication module 13 transmits the network group data to the first storing module 14 for backup storing. Next, the first communication module 13 may send a query signal to the second communication module 23 every time interval. In one embodiment, the time interval may be one second, and the query signal may be a package. The second processing module 22 will determine whether a normal signal (ack) is outputted to the first communication module 13, after the second communication module 23 of the second processing module 22 receives the query signal. The first communication module 13 then outputs the normal signal (ack) to the first processing module 12. In response to the received status of the normal signal, the first processing module 12 determines whether the primary Zigbee coordinator 2 is abnormal. The primary Zigbee coordinator 2 can be determined to be abnormal if the first processing module 12 judges that the first communication module 13 does not receive the normal signal, and the first wireless transceiver 11 will be turned on to generate RF. At the moment, the routers 31 and 32 are connected to the first wireless transceiver 11 via the RF of the first wireless transceiver 11 (shown in FIG. 2) to assign the back-up Zigbee coordinator 1 as the main coordinator of the current Zigbee network system. The back-up Zigbee coordinator 1 sends a mail to the user mailbox 5 to notify a user to recover the primary Zigbee coordinator 2 or install another backup Zigbee coordinator (not shown in figure) into the current Zigbee network system. Oppositely, the primary Zigbee coordinator 2 is determined to function normally if the first processing module 12 judges that the first communication module 13 has received the normal signal, and the query signal will still be sent to the second communication module 23 every the interval for a period of time.

In the embodiment, the first communication module 13 sends the query signals under some situations: the back-up Zigbee coordinator 1 is turned on or connected completely with the primary Zigbee coordinator 2; and the back-up Zigbee coordinator 1 has been turned on and linked with the primary Zigbee coordinator 2, such as in the case of network group data updated, the second communication module 23 actively outputs the network group data stored in the second storing module 24 to the first communication module 13, and the back-up Zigbee coordinator 1 may update the network group data at ally time.

In the embodiment, if the primary Zigbee coordinator 2 is wired connected to the back-up Zigbee coordinator 1 and the back-up Zigbee coordinator 1 can not instantly receive the normal signal from the primary Zigbee coordinator 2, the primary Zigbee coordinator 2 is determined to be abnormal. Provided that the primary Zigbee coordinator 2 is wirelessly connected to the back-up Zigbee coordinator 1, the first processing module 12 of the back-up Zigbee coordinator 1 may further set a counter indicative of a number of times that the first communication module 13 does not receive the normal signal from the second communication module 23 of the primary Zigbee coordinator 2. For example, if the first communication module 13 of the back-up Zigbee coordinator 1 sends the query signal to the second communication module 23 of the primary Zigbee coordinator 2, but the number of times that the first communication module 13 does not receive the normal signals feedback from the second communication module 23 of the primary Zigbee coordinator 2 has reached a threshold, the primary Zigbee coordinator 2 will be determined to be abnormal. The threshold of the number of times aforementioned may be set to be three, but is not limited to in the present invention.

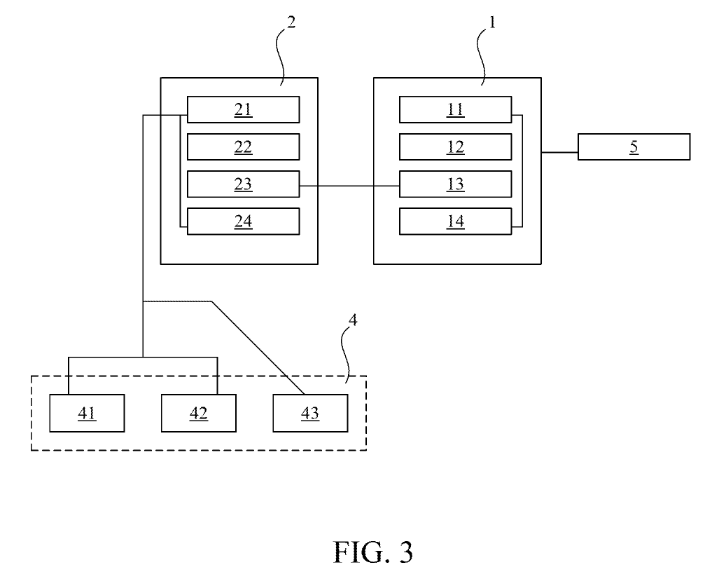

Next, FIG. 3 is a schematic block diagram illustrating a second exemplary Zigbee network system according to the present invention.

Shown in FIG. 3, a difference in the second embodiment and the first embodiment is mainly in the Zigbee network system of the second embodiment without routers. In the case of the signal intensity of a primary Zigbee coordinator 2′ stronger than the one of a router, the primary Zigbee coordinator 2′ is of router function itself and the Zigbee network system does not need to set a router. For the second embodiment, a back-up Zigbee coordinator 1′ and the primary Zigbee coordinator 2′ of the Zigbee network system are of router functions. Other relationship of signal transmission, connection relationship of the back-up Zigbee coordinator 1′ and the back-up Zigbee coordinator 2′, relationship of component connection, and back-up method are similar to the ones of the first embodiment, so they are not repeated herein.

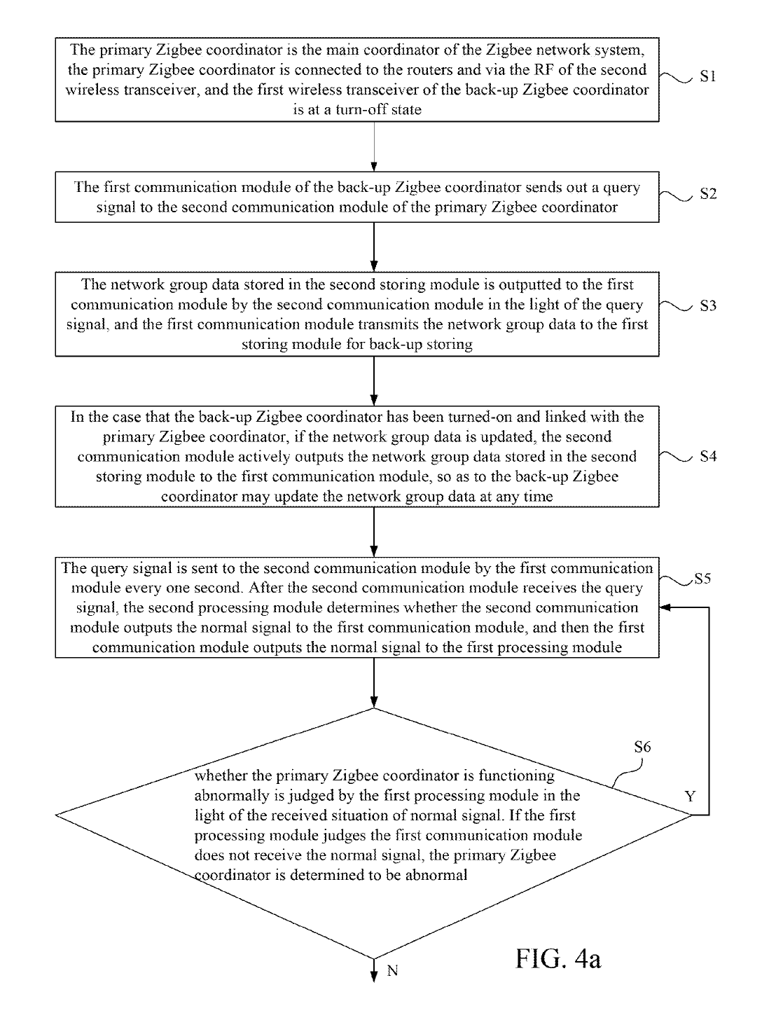

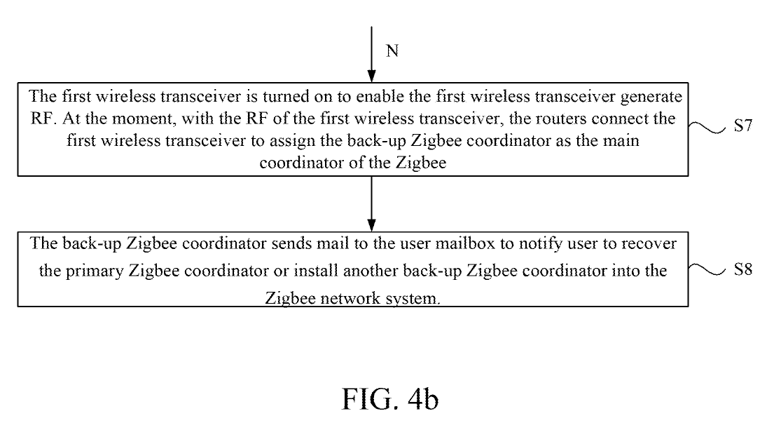

Next, please refer to FIG. 4a and FIG. 4b in company with FIG. 1 and FIG. 2. FIG. 4a and FIG. 4b are schematic flow diagrams illustrating a backup method for the first exemplary Zigbee network system according to the present invention. The backup method includes the steps as follows:

Step S1: In the case that the primary Zigbee coordinator 2 is the main coordinator of the Zigbee network system, the primary Zigbee coordinator 2 is connected to the routers 31 and 32 via the RF of the second wireless transceiver 21, and the first wireless transceiver 11 of the back-up Zigbee coordinator 1 is at a turn-off state. Next, go to step S2.

Step S2: the first communication module 13 of the back-up Zigbee coordinator 1 sends out a query signal to the second communication module 23 of the primary Zigbee coordinator 2. Next, go to step S3.

Step S3: the network group data stored in the second storing module 24 is outputted to the first communication module 13 by the second communication module 23 in the light of the query signal, and the first communication module 13 transmits the network group data to the first storing module 14 for back-up storing. Next, go to step S4.

Step S4: In the case that the back-up Zigbee coordinator 1 has been turned-on and linked with the primary Zigbee coordinator 2, if the network group data is updated, the second communication module 23 actively outputs the network group data stored in the second storing module 24 to the first communication module 13, so as to the back-up Zigbee coordinator 1 may update the network group data at any time. Next, go to step S5.

Step S5: the query signal is sent to the second communication module 23 by the first communication module 13 every one second. After the second communication module 23 receives the query signal, the second processing module 22 determines whether the second communication module 23 outputs the normal signal to the first communication module 13, and then the first communication module 13 outputs the normal signal to the first processing module 12. Next, go to step S6.

Step S6: whether the primary Zigbee coordinator 2 is functioning abnormally is judged by the first processing module 12 in the light of the received situation of normal signal. If the first processing module 12 judges the first communication module 13 does not receive the normal signal, the primary Zigbee coordinator 2 is determined to be abnormal, and go to step S7.

Step S7: the first wireless transceiver 11 is turned on to enable the first wireless transceiver 11 generate RF. At the moment, with the RF of the first wireless transceiver 11, the routers 31 and 32 connect the first wireless transceiver 11 to assign the back-up Zigbee coordinator 1 as the main coordinator of the Zigbee. Next, go to step S8.

Step S8: the back-up Zigbee coordinator 1 sends mail to the user mailbox 5 to notify user to recover the primary Zigbee coordinator 2 or install another back-up Zigbee coordinator (not shown in figure) into the Zigbee network system.

On the other hand, if the primary Zigbee coordinator 2 judges the first communication module 13 has received the normal signal in step S6, the primary Zigbee coordinator 2 is determined to be functioning normally, and step 5 in which the query signal is sent to the second communication module 23 every time interval can be executed again.

In the embodiment, the Zigbee network system may be a mesh type system, star type or tree type one, but it is not limited to in the present invention.

In the embodiment, user may judge whether the primary Zigbee coordinator 2 is abnormal by checking log of network data from the primary Zigbee coordinator 2.

In these embodiments, the network group data stored in the primary Zigbee coordinator 2 can be instantly back-up into the back-up Zigbee coordinator 1, and the back-up Zigbee coordinator 1 can instantly replace the malfunction primary Zigbee coordinator 2 without reinitializing the Zigbee network. Accordingly, a malfunction Zigbee coordinator can not interrupt data transmission in the Zigbee network in the present invention, so that user can seamlessly go on data transmission.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A Zigbee network system comprising:
a primary Zigbee coordinator;
a Zigbee router wirelessly connected with the primary Zigbee coordinator; and
a back-up Zigbee coordinator communicatively coupled with the primary Zigbee coordinator and configured to receive a network group data from the primary Zigbee coordinator,
wherein the back-up Zigbee coordinator is further configured to send a query signal to the primary Zigbee coordinator, and includes a first wireless transceiver configured to become operational to wirelessly connect with the Zigbee router if the back-up Zigbee coordinator does not receive a query response indicating the primary Zigbee coordinator is functioning normally.

2. The Zigbee network system of claim 1, wherein the back-up Zigbee coordinator further comprises:
a first communication module connected to the primary Zigbee coordinator, the first communication module configured to send a network group data request signal and the query signal, and further configured to receive the network group data and the query response;
a first storing module configured to store the network group data received by the first communication module; and
a first processing module configured to determine a status of the primary Zigbee coordinator based on whether the query response is received, the first processing module being further configured to instruct the first wireless transceiver to turn on and become operational if the Zigbee coordinator is in an abnormal status.

3. The Zigbee network system of claim 2, wherein the primary Zigbee coordinator comprises:
a second wireless transceiver configured to generate a signal and transmit the network group data;
a second communication module connected to the first wireless transceiver of the first communication module, the second communication module being configured to receive the network group data request signal and the query signal, and further configured to send the network group data and the query response to the first communication module;
a second processing module configured to instruct the second communication module to send the query response to the first communication module; and
a second storing module configured to store the network group data.

4. The Zigbee network system of claim 3, wherein the second communication module is configured to transmits the network group data to the first communication module if the network group data is updated.

5. The Zigbee network system of claim 3, wherein the primary Zigbee coordinator is wirelessly connected to the back-up Zigbee coordinator, and wherein the first processing module of the back-up Zigbee coordinator is further configured to set a counter indicative of a number of times the first communication module of the back-up Zigbee coordinator does not received the query response from the primary Zigbee coordinator.

6. The Zigbee network system of claim 3, wherein the first communication module is configured to transmit the query signal to the second communication module every one second.

7. The Zigbee network system of claim 1, wherein the network group data includes at least one of: a personal area network ID; a long address; a short address; and a routing table.

8. The Zigbee network system of claim 1, being at least one of the following: a mesh type; a star type; and a tree type.

9. A Zigbee coordinator configured to communicatively couple with a counterpart Zigbee coordinator, the Zigbee coordinator comprising:
a communication module configured to send a query signal to the counterpart Zigbee coordinator, and further configured to receive a network group data from the counterpart Zigbee coordinator;
a storage module configured to store the network group data; and
a wireless transceiver configured to become operative to wirelessly connect the Zigbee coordinator with a Zigbee router if the Zigbee coordinator does not receive a query response indicating the counterpart Zigbee coordinator is functioning normally.

10. The Zigbee coordinator of claim 9, wherein the network group data includes at least one of a personal area network ID; a long address; a short address; and a routing table.

11. The Zigbee coordinator of claim 9, further including a counter indicative of a number of times the Zigbee coordinator does not receive the query response from the counterpart Zigbee coordinator.

12. The Zigbee coordinator of claim 9, further configured to periodically transmit the query signal.

13. The Zigbee coordinator of claim 12, wherein the query signal transmits periodically every one second.

14. The Zigbee coordinator of claim 9, further configured to connect with at least one Zigbee router and form at least one of the following type of Zigbee network system: a mesh type; a star type; and a tree type.

15. A method for substituting a primary Zigbee coordinator in a Zigbee network system, the method comprising:
providing a back-up Zigbee coordinator communicatively coupled with the primary Zigbee coordinator, the back-up Zigbee coordinator comprising a memory storing a network group data received from the primary Zigbee coordinator;
querying if the primary Zigbee coordinator is functioning normally; and
if the primary Zigbee coordinator is not functioning normally, connecting the back-up Zigbee coordinator to the Zigbee network system using the network group data.

16. The method of claim 15, further including setting a tolerance time period during which the back-up Zigbee coordinator does not receive a response from the primary Zigbee coordinator.

17. The method of claim 16, further including:
determining if the tolerant time period reaches a tolerance threshold;
turning on a wireless communication module of the back-up Zigbee coordinator; and
using the wireless communication module to connect the back-up Zigbee coordinator to a Zigbee router of the Zigbee network system.

18. The method of claim 15, further including sending a network group data request signal from the back-up Zigbee coordinator to the primary Zigbee coordinator.

19. The method of claim 15, wherein the querying is performed at regular time intervals.

20. The method of claim 19, wherein the regular time interval is once every one second.
